(19) United States
(12) Patent Application Publication
(10) Pub. No.: US 2008/0229030 A1
(43) Pub. Date: Sep. 18, 2008

(54) Efficient Use of Memory Ports in Microcomputer Systems

(76) Inventors: Hyun-Wook Ha, Ansan-si (KR); Jong-Ho, Suwon-si (KR)

Correspondence Address: F. CHAU & ASSOCIATES, LLC, 130 WOODBURY ROAD, WOODBURY, NY, 11797, US

(21) Appl. No.: 12/046,931

(22) Filed: Mar. 12, 2008

(30) Foreign Application Priority Data
Mar. 14, 2007 (KR) 10-2007-0025214

(51) Int. Cl. G06F 12/00

(52) U.S. Cl. 711/149; 711/E12.001

(57) ABSTRACT

A microcomputer system includes first and second IP blocks, a multi-port memory, a shared memory field allocated to the second IP block, and a second memory field. A first memory controller is configured to control access to the first and shared memory fields. A second memory controller is configured to control access to the second and shared memory fields. A bus controller operates in response to access request signals provided from the first and second IP blocks. When the second memory controller is in a ready state and the first and second IP blocks request access to the first and shared memory fields, the bus controller provides the first memory controller with access to the access request signal of the first IP block and provides the second memory controller with access to the access request signal of the second IP block.

### CROSS-REFERENCE TO RELATED APPLICATIONS

This application claims priority under 35 U.S.C. §119 to Korean Patent Application No. 10-2007-0025214, filed on Mar. 14, 2007, the entire contents of which are incorporated herein by reference.

### BACKGROUND OF THE INVENTION

1. Technical Field

The present invention disclosed herein relates to microcomputer systems and more particularly, to an efficient use of memory ports in microcomputer systems.

2. Discussion of Related Art

A microcomputer system generally includes a mobile processor, a memory, and one or more memory ports. The mobile processor typically has a central processing unit (CPU), a plurality of internet protocol (IP) blocks, and a bus controller. The IP blocks are provided to access the memory, including a 2-dimensional (2D) accelerator, a display controller, a direct memory access (DMA) controller, and a joint picture expert group (JPEG) decoder. The plural IP blocks operate to access the memory, which is divided into a plurality of fields, corresponding to the plurality of memory ports by the bus controller.

In one example, the microcomputer system has a dual port memory. The dual port memory includes a first memory field, a shared memory field, and a second memory field. The mobile processor of the microcomputer system includes two memory ports. The first memory field and the shared memory field are accessed through the first memory port. The second memory field and the shared memory field are accessed through the second memory port. A bus controller determines a sequence of access to the IP blocks in accordance with priority information internally stored, when there are requests for memory access by the IP blocks. Then, the IP blocks access the memory in accordance with the sequence by the priority information under regulation of the bus controller.

IP blocks for accessing the first and shared memory fields through the first memory port, and IP blocks for accessing the second and shared memory fields through the second memory port are selected by software. The determination of whether to access the memory fields through the first or second port is mapped in hardware architecture. Selecting the memory fields to be accessed through the first and second ports by the IP blocks is dependent on a software system. This software is reserved in a storage area of the microcomputer system and carried out by the CPU.

Under this condition, the IP blocks accessing the memory by the first memory port may request memory access while the IP blocks accessing the memory through the second memory port do not request memory access. In this case, the IP blocks access the first and shared memory fields through the first memory port rather than through the second memory port. As the first and shared memory fields are accessed through the first memory port rather than through the second memory port, use of the memory ports is relatively inefficient. Due to the inefficiency in using the memory ports, performance of the microcomputer system may be degraded.

### SUMMARY OF THE INVENTION

Exemplary embodiments of the present invention are directed to providing a microcomputer system and a memory access method capable of efficiently using memory ports.

According to an exemplary embodiment of the present invention, a microcomputer system includes first and second IP blocks; a multi-port memory having a first memory field allocated to the first IP block, a shared memory field allocated to the second IP block, and a second memory field. A first memory controller is configured to control access to the first and shared memory fields in response to a first access request signal. A second memory controller is configured to control access to the second and shared memory fields in response to a second access request signal. A bus controller, operating in response to access request signals, is provided from the first and second IP blocks in response to access requests of the first and second IP blocks. If the second memory controller is in a ready state and the first and second IP blocks request access to the first and shared memory fields, the bus controller provides the first memory controller with the first access request signal corresponding to the access request signal of the first IP block and provides the second memory controller with the second access request signal corresponding to the access request signal of the second IP block.

The first memory controller may access the first memory field through a port in response to the first access request signal.

The second memory controller may access the shared memory field through a port in response to the second access request signal.

The access requests of the first and second IP blocks may occur either at the same time, separately, or one after the other.

A region of the shared memory field accessed by the first memory controller may be allocated differently from a region of the shared memory field accessed by the second memory controller.

The access request signal may contain a base address.

The bus controller may convert a base address of the access request signal of the second IP block into a base address of the shared memory field accessed by the second memory controller, and output the converted base address as the second access request signal.

The microcomputer system may further include a third IP block allocated to the second memory field and a fourth IP block allocated to the shared memory field.

If the third and fourth IP blocks request access to the second and shared memory fields, the bus controller may provide the first memory controller with the first access request signal corresponding to the access request signals of the first and second IP blocks and provide the second memory controller with the second access request signal corresponding to the access request signals of the third and fourth IP blocks.

The first memory controller may access the first and shared memory fields through a port in response to the first access request signal.

The second memory controller may access the second and shared memory fields through a port in response to the second access request signal.

The microcomputer system may further include a multi-port memory having a plurality of memory fields. A plurality of memory controllers is configured to access the plural memory fields and the shared memory field, corresponding to the plural memory fields. A plurality of IP blocks is allocated to the plural memory fields. A plurality of IP blocks is allocated to the shared memory field.

The bus controller may include an address decoder receiving the access request signals from the first and second IP blocks. A first port arbiter receives the access request signals of the first and second IP blocks from the address decoder. A second port arbiter and first and second multiplexers corresponding to the first and second port arbiters are also included in the bus controller. The first port arbiter controls the first multiplexer with reference to status of the first and second memory controllers and provides the access request signal of the first IP block to the first memory controller as the first access request signal through the first multiplexer. The second port arbiter controls the second multiplexer with reference to status of the first and second memory controllers and provides the access request signal of the second IP block to the second memory controller as the second access request signal through the second multiplexer.

The first port arbiter may convert a base address of the access request signal of the second IP block into a base address of the shared memory field accessed by the second memory controller.

The address decoder may further receive access request signals from third and fourth IP blocks and provide the access request signals of the third and fourth IP blocks to the second port arbiter.

The first port arbiter may control the first multiplexer by status signals of the first and second memory controllers and provide the access request signals of the first and second IP blocks to the first memory controller as the first access request signal through the first multiplexer.

The second port arbiter may control the second multiplexer by status signals of the first and second memory controllers and provide the access request signals of the third and fourth IP blocks to the second memory controller as the second access request signal through the second multiplexer.

The first port arbiter may includes a first FIFO circuit, a second FIFO circuit, a first arbiter logic circuit storing the access request signals in the first FIFO circuit and storing the access request signal in the second FIFO circuit, and a base address conversion circuit. The base address conversion circuit converts a base address of the access request signal of the second IP block, which is output from the second FIFO circuit, into a base address of the shared memory field accessed by the second memory controller. The first arbiter logic circuit generates first and second count signals by the first and second memory controllers. The first FIFO circuit outputs the access request signal of the first IP block in response to the first count signal. The second FIFO circuit outputs the access request signal of the second IP block in response to the second count signal.

The first FIFO circuit may provide the access request signal of the first IP block to the first memory controller as the first access request signal through the first multiplexer.

The base address conversion circuit may provide the access request signal of the second IP block, which is converted from the base address, to the second memory controller as the second access request signal through the second multiplexer.

The first count signal may designate a point, without conducting a counting operation for an interval of the first FIFO circuit storing the access request signal of the first IP block.

If the second port arbiter provides the access request signals of the third and fourth IP blocks to the second memory controller as the second access request signal through the second multiplexer, then the first FIFO circuit may output the access request signals of the first and second IP blocks in response to the first count signal.

The second FIFO circuit may designate a point for an interval storing the access request signal of the second IP block and may withhold the access request signal of the second IP block.

### BRIEF DESCRIPTION OF THE DRAWINGS

Non-limiting and non-exhaustive exemplary embodiments of the present invention will be described with reference to the following figures, wherein like reference numerals may refer to like parts throughout the various figures. In the figures:

FIG. 1 is a block diagram of a microcomputer system according to an exemplary embodiment of the present invention;

FIG. 2 is a block diagram of the bus controller shown in FIG. 1;

FIG. 3 is a block diagram of the first port arbiter shown in FIG. 2;

FIG. 4 is a block diagram of the second port arbiter shown in FIG. 2;

FIG. 5 is a diagram illustrating a base address of the allocated memory fields shown in FIG. 1; and

FIG. 6 is a block diagram of a microcomputer system according to an exemplary embodiment of the present invention.

### DETAILED DESCRIPTION OF EXEMPLARY EMBODIMENTS

Exemplary embodiments of the present invention will be described below in more detail with reference to the accompanying drawings. The present invention may, however, be embodied in different forms and should not be constructed as limited to the embodiments set forth herein. Like reference numerals may refer to like elements throughout the accompanying figures.

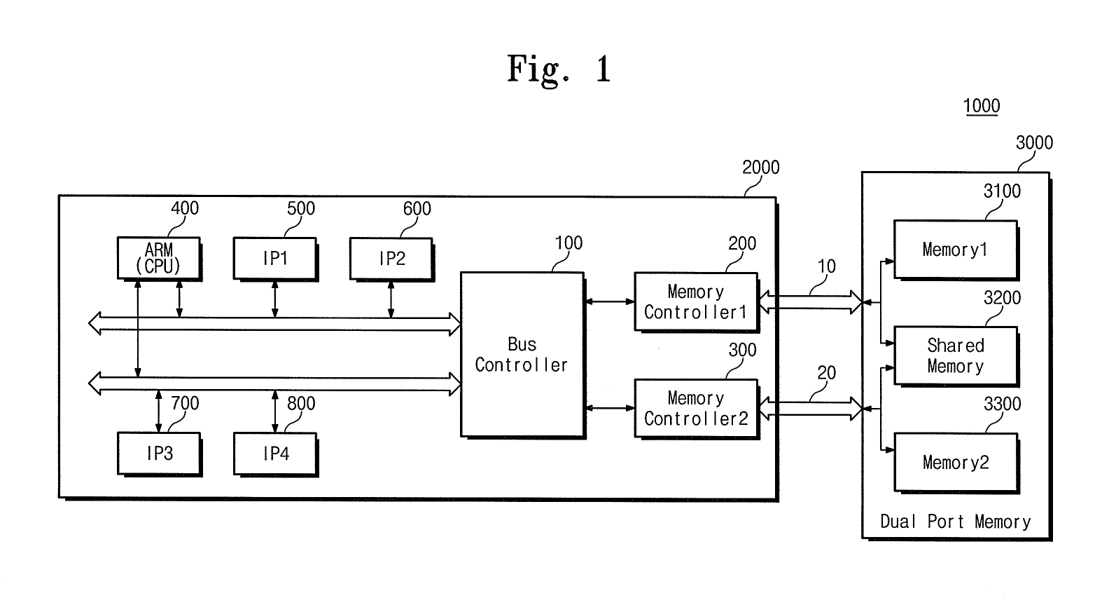

FIG. 1 is a block diagram of a microcomputer system according to an exemplary embodiment of the present invention.

Referring to FIG. 1, the microcomputer system 1000 according to an exemplary embodiment of the present invention includes a microprocessor 2000, a memory 3000, and memory ports 10 and 20.

The microprocessor 2000 accesses the memory 3000 by way of the memory ports 10 and 20.

While there are two memory ports shown in FIG. 1, it is permissible for the microcomputer system 1000 to include additional memory ports. A feature of accessing the memory 3000 through the two memory ports 10 and 20 in the microcomputer system 1000 is described below.

The microprocessor 2000 includes a bus controller 100, a first memory controller 200, a second memory controller 300, a CPU 400, and IP blocks 500, 600, 700, and 800 (500 through 800). The memory 3000 is a kind of multi-port memory. According to an exemplary embodiment, the memory 3000 is configured in dual port structure and is thus a dual port memory. The memory 3000 includes a first memory field 3100, a shared memory field 3200, and a second memory field 3300.

The CPU 400 controls an overall operation of the microprocessor 2000. The CPU 400 controls operations of functional blocks included in the microprocessor 2000.

The IP blocks 500 through 800 are provided for accessing the memory 3000, including a 2D accelerator, a display controller, a DMA controller, and a JPEG decoder. The microprocessor 2000 according to an exemplary embodiment of the present invention has four IP blocks 500through 800. Additional IP blocks may also be included.

The IP blocks 500 through 800 may determine whether to use the first memory port or the second memory port, or to access one of the memory fields 3100, 3200, and 3300 through the first and second memory ports.

The IP blocks 500 through 800 request access from the bus controller 100 to access to allocated memory fields. The IP blocks 500 through 800 output access request signals by the access request.

The bus controller 100 determines an access sequence for the IP blocks 500 through 800 in accordance with internal priority information when the access request signals are removes. The bus controller 100 provides the first memory controller 200 with the access request signals of the IP blocks, which use the first memory port 10, in accordance with the priority information. In addition, the bus controller 100 provides the second memory controller 300 with the access request signals of the IP blocks, which use the second memory port 20, in accordance with the priority information.

The first memory controller 200 conducts an access operation to the first memory field 3100 or the shared memory field 3200 of the memory 3000 through the first memory port 10 in response to the access request signals provided from the IP blocks. The second memory controller 300 conducts an access operation to the second memory field 3300 or the shared memory field 3200 of the memory 3000 through the second memory port 20 in response to the access request signals provided from the IP blocks.

The access request signals of the IP blocks 500 through 800 are address and data signals. While accessing the memory 3000, the first and second memory controllers 200 and 300 write or read data into and from the memory fields 3100 through 3300 designated by addresses.

When the IP blocks 500 and 600 accessing the memory 3000 through the first memory port 10 and the IP blocks 700 and 800 accessing the memory 3000 through the second memory port 20 output the access request signals, the microprocessor 2000 operates as follows.

The IP blocks 500 through 800 provide the access request signals to the bus controller 100. The first and second memory controllers, 200 and 300, are conditioned in a busy state.

In an exemplary embodiment, it is assumed that the first and second IP blocks 500 and 600 access the memory 3000 through the first memory port 10 and the first IP block 500 is of a higher priority than the second IP block 600 on the bus. It is also assumed that the first and second IP blocks 500 and 600 are configured to access the first and shared memory fields 3100 and 3200, respectively, through the first memory port 10. For example, the first IP block 500 is allocated to the first memory field 3100 while the second IP block 600 is allocated to the shared memory field 3200.

If the first and second IP blocks 500 and 600 apply the access request signals to the bus controller 100, the bus controller 100 first enables the first IP block 500 to access the first memory field 3100 by the priority information of the first and second IP blocks 500 and 600. The bus controller 100 provides the first memory controller 200 with the access request signal of the first IP block 500. The first memory controller 200 conducts access to the first memory field 3100 of the memory 3000 through the first memory port 10 in response to the access request signal of the first IP block 500 which is provided from the bus controller 100.

After applying the access request signal of the first IP block 500 to the first memory controller 200, the bus controller 100 further provides the access request signal of the second IP block 600 to the first memory controller 200. The first memory controller 200 provides access to the shared memory field 3200 of the memory 3000 through the first memory port 10 in response to the access request signal of the second IP block 600 which is provided from the bus controller 100.

It is also assumed that the third and fourth IP blocks 700 and 800 access the memory 3000 through the second memory port 20 and the third IP block 700 is allocated to the second memory field 3300 while the fourth IP block 800 is allocated to the shared memory field 3200. In this case, an access operation to the memory fields 3200 and 3300 through the second memory port 30 is similar to the aforementioned access operation to the memory 3000 through the first memory port 10, but different in the fact that the memory fields to be accessed are the second memory field 3300 and the shared memory field 3200.

The access request signal output to the first memory controller 200 from the bus controller 100 may be referred to as a first access request signal, and the access request signal output to the second memory controller 300 from the bus controller 100 may be referred to as a second access request signal. The access request signals of the IP blocks 500 and 600 from the bus controller 100 correspond to the first access request signal, and the access request signals of the IP blocks 700 and 800 correspond to the second request signal.

When the IP blocks 500 and 600 accessing the memory 3000 through the first memory port 10 output the access request signals while the IP blocks 700 and 800 access the memory 3000 through the second memory port 20, the access request signals are withheld and the microcomputer system 2000 operates as follows.

The first and second IP blocks 500 and 600 output their access request signals while the third and fourth IP blocks 700 and 800 withhold their access request signals. In this case, the first memory controller 200 is in a busy state while the second memory controller 300 is in a ready state.

Accordingly, the bus controller 100 receives the access request signals of the first and second IP blocks 500 and 600 for using the first memory port 10, rather than from the third and fourth IP blocks 700 and 800 for using the second memory port 20. In this case, the bus controller 100 provides the first memory controller 200 with the access request signal of the first IP block 500 for accessing the first memory field 3100, which is selected from the access request signals of the IP blocks 500 and 600 using the first memory port 10. The bus controller 100 provides the second memory controller 300 with the access request signal of the second IP block 600 for accessing the shared memory field 3200, which is selected from the access request signals of the IP blocks 500 and 600 using the first memory port 10.

In this case, the access request signal of the first IP block 500, which is output from the bus controller 100, corresponds to the first access request signal, and the access request signal of the second IP block 600 corresponds to the second access request signal.

The first memory controller 200 accesses the first memory field 3100 of the memory 3000 through the first memory port 10 in response to the access request signal of the first IP block 500. The second memory controller 300 accesses the shared memory field 3200 of the memory 3000 through the second memory port 20 in response to the access request signal of the second IP block 600. Thus, the microprocessor 2000 is able to use the second memory port 20 while there is no output of the access request signals from the IP blocks 700 and 800 using the second memory port 20.

The shared memory field 3200 accessed through the first memory port 10 is arranged differently than the shared memory field 3200 that is accessed through the second memory port 20. If the IP blocks 700 and 800 do not generate the access request signals, an address of the access request signal for accessing the shared memory field 3200 through the second memory port 20 is the address for accessing the shared memory field 3200 through the first memory port 10. Therefore, the bus controller 100 converts an address of the access request signal, which is provided to the second memory controller 300, into an address for accessing the shared memory field 3200, for example, as described below.

When the IP blocks 700 and 800, using the second memory port 20, output their access request signals while the IP blocks 500 and 600 withhold their access request signals, the microprocessor 200 may operate as described above.

The microcomputer system 1000 is configured to use the memory port that is set to be used by the IP blocks without outputting the access requesting signals. The microcomputer system 1000 is able to access the memory 3000 by efficiently using the memory ports 10 and 20.

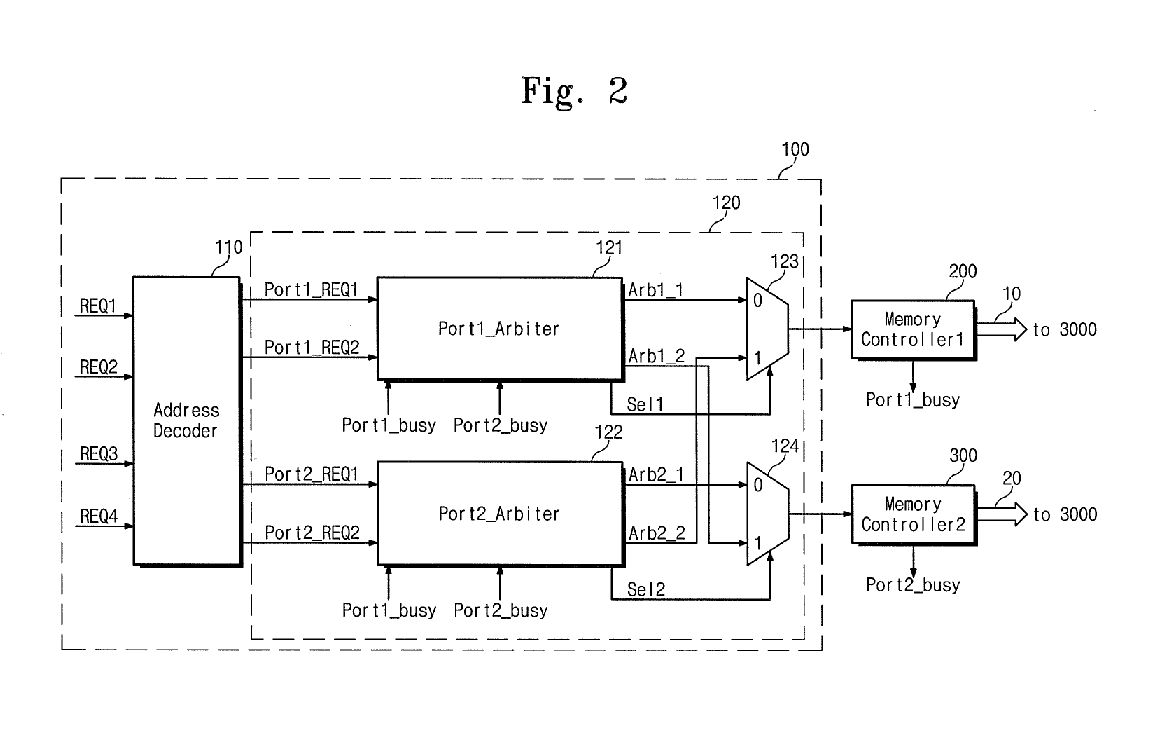

FIG. 2 is a block diagram of the bus controller 100 shown in FIG. 1.

Referring to FIG. 2, the bus controller 100 according to an exemplary embodiment of the present invention is comprised of an address decoder 110 and an adaptive memory-access logic block 120. The adaptive memory-access logic block 120 includes a first port arbiter 121, a second port arbiter 122, a first multiplexer 123, and a second multiplexer 124.

When the IP blocks 500through 800 access the memory 3000 by way of the first and second memory ports 10 and 20, an operation of the bus controller 110 is as follows.

Allocation of the IP blocks to the memory fields may be performed as discussed above.

The address decoder 110 receives the access request signals REQ1 through REQ4 from the IP blocks 500 through 800. If there are more than four IP blocks, the address decoder 110 may accept more access request signals, e.g., REQ1 through REQn. The access request signals REQ1 through REQ4 are provided from the IP blocks 500 through 800 and use the first and second memory ports 10 and 20. The address decoder 110 classifies the access request signals REQ1 through REQ4 into the access request signals Port1_REQ1 and Port1_REQ2 of the IP blocks 500 and 600 and the access request signals Port2_REQ1 and Port2_REQ2 of the IP blocks 700 and 800. The access request signals Port1_REQ1 and Port1_REQ2 of the IP blocks 500 and 600 use the first memory port 10 and the access request signals Port2_REQ1 and Port2_REQ2 of the IP blocks 700 and 800 use the second memory port 20. In practice, the address decoder 110 divides the access request signals Port1_REQ1 and Port1_REQ2, and the access request signals Port2_REQ1 and Port2_REQ2 from the primitive access request signals REQ1 through REQ4.

The address decoder 110 provides the classified access request signals, Port1_REQ1, Port1_REQ2, Port2_REQ1, and Port2_REQ2, to the adaptive memory-access logic block 120.

The adaptive memory-access logic block 120 controls the IP blocks 500 through 800 to efficiently use the first and second memory ports 10 and 20 in response to the access request signals Port1_REQ1, Port1_REQ2, Port2_REQ1, and Port2_REQ2.

The first port arbiter 121 of the adaptive memory-access logic block 120 receives the access request signals Port1_REQ1 and Port1_REQ2 of the IP blocks 500 and 600 from the address decoder 110. The second port arbiter 122 of the adaptive memory-access logic block 120 receives the access request signals Port2_REQ1 and Port2_REQ2 of the IP blocks 700 and 800 from the address decoder 110.

The first memory controller 200 generates and provides a first port control signal Port1_busy to the first and second port arbiters 121 and 122. The second memory controller 300 generates and provides a second port control signal Port2_busy to the first and second port arbiters 121 and 122. The first and second port control signals Port1_busy and Port2_busy are uses as status signals of the first and second memory controllers 200 and 300.

The first port control signal Port1_busy is set to a high level when the access request signals Port1_REQ1 and Port1_REQ2 of the IP blocks 500 and 600 are applied to the address decoder 110. The second port control signal Port2_busy is set to a high level when the access request signals Port2_REQ1 and Port2_REQ2 of the IP blocks 700 and 800 are applied to the address decoder 110.

As the IP blocks 500 through 800 provide the address decoder 110 with the access request signals REQ1 through REQ4 for using the first and second memory ports 10 and 20, the first and second port control signals Port1_busy and Port2_busy are set to high levels.

The first port arbiter 121 generates a first selection signal Sel1 of a low level in response to the first and second port control signals Port1_busy and Port2_busy which are at high levels. The first selection signal Sel1 is applied to the first multiplexer 123.

The second port arbiter 122 generates a second selection signal Sel2 of a low level in response to the first and second port control signals Port1_busy and Port2_busy which are at high levels. The second selection signal Sel2 is applied to the second multiplexer 124.

The first port arbiter 121 outputs the access request signals Port1_REQ1 and Port1_REQ2 of the IP blocks 500 and 600 through a first output terminal Arb1_1. The first port arbiter 121 is storing priority information of the IP blocks 500 and 600, outputting the access request signals Port1_REQ1 and Port1_REQ2 of the IP blocks 500 and 600 in the sequence according to the priority information.

The multiplexer 123 provides the first memory controller 200 with the access request signals Port1_REQ1 and Port1_REQ2, which are output through the first output terminal Arb1_1 of the first port arbiter 121 by the first selection signal Sel1, as the first access request signal. The first memory controller 200 accesses the first memory field 3100 in response to the first access request signal Port1_REQ1. The first memory controller 200 also accesses the shared memory field 3200 in response to the first access request signal Port1_REQ2.

The second port arbiter 122 is similar to the first port arbiter 121 in operation. However, the access request signals Port2_REQ1 and Port2_REQ2 of the IP blocks 700 and 800, which are output from the second port arbiter 122, are provided to access the second and shared memory fields 3300 and 3200.

When the IP blocks 500 and 600 assigned to access the memory through the first memory port 10 output the access request signals REQ1 and REQ2 while the IP blocks 700 and 800 assigned to the memory through the second memory port 20 withhold the access request signals REQ3 and REQ4, an operation of the bus controller 110 is as follows.

The address decoder 110 receives the access request signals REQ1 and REQ2 of the IP blocks 500 and 600 and not the access request signals REQ3 and REQ4 of the IP blocks 700 and 800. The address decoder 110 outputs the access request signals REQ1 and REG2 as the access request signals Port1_REQ1 and Port1_REQ2 of the IP blocks 500 and 600 to be accessed through the first memory port 10. The address decoder 110 provides the access request signals Port1_REQ1 and Port1_REQ2 of the IP blocks 500 and 600 to the first port arbiter 121.

The first port control signal Port1_busy generated from the first memory controller 200 is set to a high level. The second port control signal Port2_busy generated from the second memory controller 300 is set to a low level because the IP blocks 700 and 800 hold to output the access request signals REQ3 and REQ4 to the address decoder 110.

The first port arbiter 121 receives the first port control signal Port1_busy of a high level and the second port control signal Port2_busy of a low level. The first port arbiter 121 generates the first selection signal Sel1 of a low level in response to the first port control signal Port1_busy of a high level and the second port control signal Port2_busy of a low level. The first selection signal Sel1 is applied to the first multiplexer 123.

The second port arbiter 122 receives the first port control signal Port1_busy of a high level and the second port control signal Port2_busy of a low level. The second port arbiter 122 generates the second selection signal Sel2 of a low level in response to the first port control signal Port1_busy of a high level and the second port control signal Port2_busy of a low level. The second selection signal Sel2 is applied to the second multiplexer 124.

The first port arbiter 121 outputs the access request signal Port1_REQ1 of the first IP block 500 for accessing the first memory field 3100, which is selected from the access request signals Port1_REQ1 and Port1_REQ2 of the IP blocks 500 and 600, 10 through the first output terminal Arb1_1. The first multiplexer 123 provides the first memory controller 200 with the access request signal Port1_REQ1. The access request signal port1_REQ1 is output through the first output terminal Arb1_1 of the first port arbiter 121 as the first access request signal in response to the first selection signal Sel1 of low level. The first memory controller 200 accesses the first memory field 3100 in response to the first access request signal Port1_REG1.

The first port arbiter 121 outputs the access request signal Port1_REQ2 of the second IP block 600 for accessing the shared memory field 3200, which is selected from the access request signals Port1_REQ1 and Port1_REQ2 of the IP blocks 500 and 600, through the second output terminal Arb1_2. The second multiplexer 124 provides 20 the second memory controller 300 with the access request signal Port1_REQ2. The access request signal Port1_REQ2 is output through the second output terminal Arb1_2 of the first port arbiter 121 as the second access request signal in response to the second selection signal Sel2 of a high level. The second memory controller 300 accesses the shared memory field 3200 in response to the second access request signal Port1_REG2.

The shared memory field 3200 accessed through the first memory port 10 is different from that accessed through the second memory port 20. Thus, the first port arbiter 121 converts an address of the access request signal Port1_REQ2, which is provided to the second memory controller 300, into an address for accessing the shared memory field 3200 through the second memory port 20, for example, as described below.

When the IP blocks 500 and 600 assigned to access the memory through the first memory port 10 withhold the access request signals REQ1 and REQ2 while the IP blocks 700 and 800 assigned to the memory through the second memory port 20 output the access request signals REQ3 and REQ4, an operation of the bus controller 110 is as follows.

The address decoder 110 receives the access request signals REQ3 and REQ4 of the IP blocks 700 and 800 and not the access request signals REQ1 and REQ2 of the IP blocks 500 and 600. The address decoder 10 outputs the access request signals REQ3 and REG4 as the access request signals Port2_REQ1 and Port2_REQ2 of the IP blocks 700 and 800 to be accessed through the second memory port 20. The address decoder 110 provides the access request signals Port2_REQ1 and Port2_REQ2 of the IP blocks 700 and 800 to the second port arbiter 122.

The second port control signal Port2_busy generated from the second memory controller 300 is set to a high level. But, the first port control signal Port1_busy generated from the first memory controller 200 is set to a low level because the IP blocks 500 and 600 withhold the access request signals REQ1 and REQ2 from the address decoder 110.

The second port arbiter 122 receives the second port control signal Port2_busy of a high level and the first port control signal Port1_busy of a low level. The second port arbiter 122 generates the second selection signal Sel2 of a low level in response to the second port control signal Port2_busy of a high level and the first port control signal Port1_busy of a low level. The second selection signal Sel2 is applied to the second multiplexer 124.

The first port arbiter 121 receives the second port control signal Port2_busy of a high level and the first port control signal Port1_busy of a low level. The first port arbiter 121 generates the first selection signal Sel1 of a high level in response to the second port control signal Port2_busy of a high level and the first port control signal Port1_busy of a low level. The second selection signal Sel2 is applied to the second multiplexer 124.

The second port arbiter 122 outputs the access request signal Port2_REQ1 of the third IP block 700 for accessing the second memory field 3300. The access request signal Port2_REQ1 is selected from the access request signals Port2_REQ1 and Port2_REQ2 of the IP blocks 700 and 800, through the first output terminal Arb2_1 thereof. The second multiplexer 124 provides the second memory controller 300 with the access request signal Port2_REQ1. The access request signal Port2_REQ1 is output through the first output terminal Arb2_1 of the first port arbiter 122, in response to the second selection signal Sel2 of a low level. The second memory controller 300 accesses the second memory field 3300 in response to the access request signal Port2_REG1.

The second port arbiter 122 outputs the access request signal Port2_REQ2 of the fourth IP block 800 for accessing the shared memory field 3200. The access request signal Port2_REQ2 is selected from the access request signals Port2_REQ1 and Port2_REQ2 of the IP blocks 500 and 600, through the second output terminal Arb2_2. The first multiplexer 123 provides the first memory controller 200 with the access request signal Port2_REQ2. The access request signal Port2_REQ2 is output through the second output terminal Arb2_2 of the second port arbiter 122, in response to the first selection signal Sel1 of a high level. The first memory controller 200 accesses the shared memory field 3200 in response to the second access request signal Port2_REG2.

The shared memory field 3200 accessed through the first memory port 10 is different from the shared memory field 3200 accessed through the second memory port 20. Thus, the second port arbiter 122 converts an address of the access request signal Port2_REQ2, which is provided to the first memory controller 200, into an address for accessing the shared memory field 3200 through the first memory port 10, for example as described below.

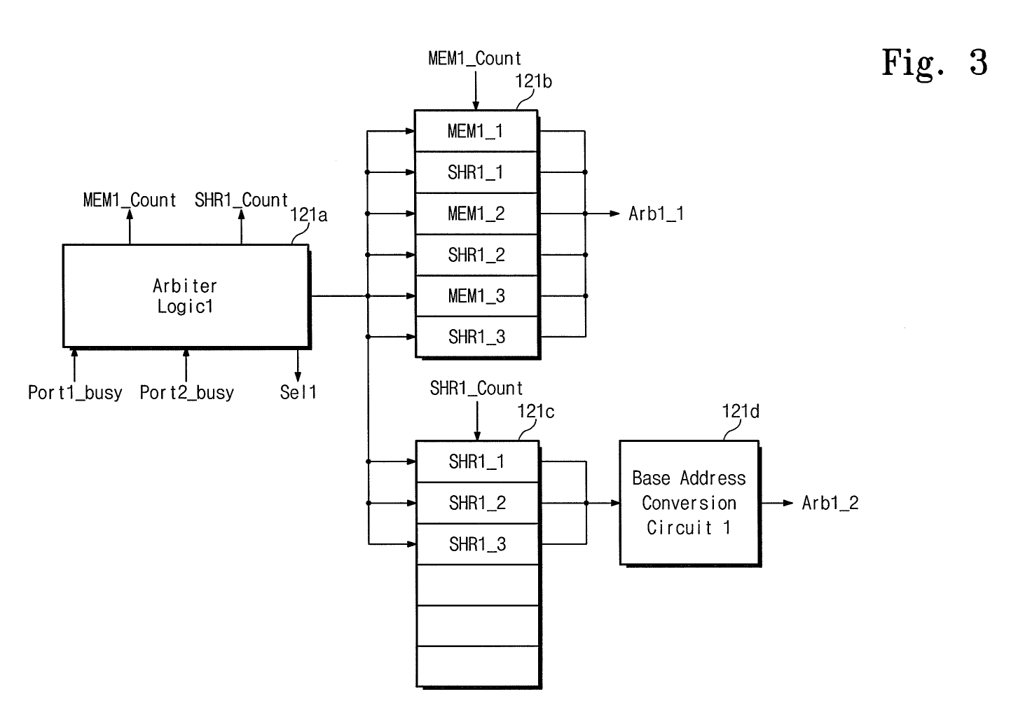

FIG. 3 is a block diagram of the first port arbiter 121 shown in FIG. 2.

Referring to FIG. 3, the first port arbiter 121 according to an exemplary embodiment of the present invention is comprised of a first arbiter logic circuit 121a, a first first-in/first-out (FIFO) circuit 121b, a second FIFO circuit 121c, and a first base address conversion circuit 121d.

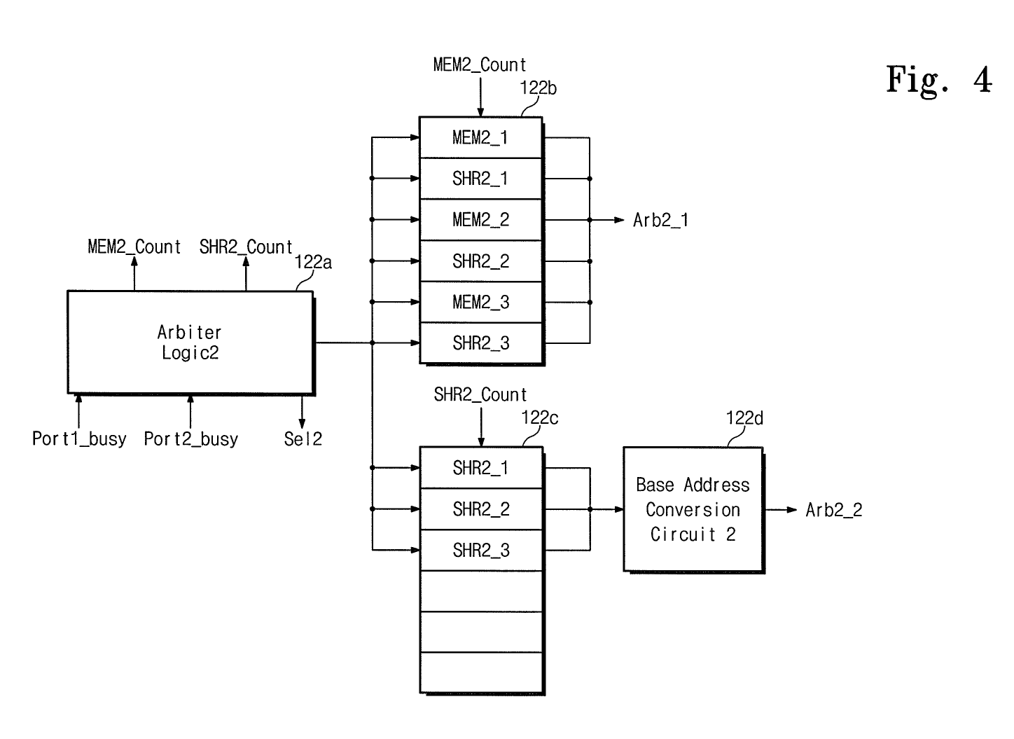

FIG. 4 is a block diagram of the second port arbiter 122 shown in FIG. 2.

Referring to FIG. 4, the second port arbiter 122 according to an exemplary embodiment of the present invention is comprised of a second arbiter logic circuit 122a, a third first-in/first-out (FIFO) circuit 122b, a fourth FIFO circuit 122c, and a second base address conversion circuit 122d.

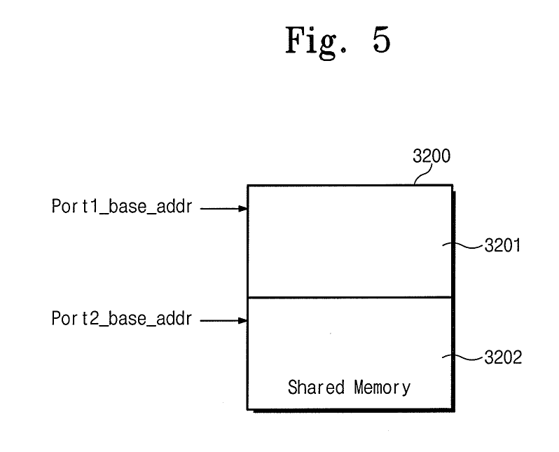

FIG. 5 is a diagram illustrating a base address of the allocated memory fields shown in FIG. 1.

The first and second port arbiters each shown in FIGS. 3 and 4 operate in a similar manner. An operation of the first port arbiter 121 shown in FIG. 3 is described below. The configuration of allocating the IP blocks 500 through 800 to the memory fields is as described above.

With reference to FIGS. 3 and 5, when the access request signals REQ1 and REQ2 of the IP blocks 500 and 600 and the access request signals REQ3 and REQ4 of the IP blocks 700 and 800 are provided to the bus controller 110, the first port arbiter 121 operates as follows.

The first arbiter logic circuit 121a of the first port arbiter 121 receives the access request signals Port1_REQ1 and Port1_REQ2 of the IP blocks 500 and 600 from the address decoder 110. The first arbiter logic circuit 121a stores the access request signals Port1_REQ1 and Port1_REQ2 of the IP blocks 500 and 600 in the first FIFO circuit 121b in accordance with the internal priority information. The first arbiter logic circuit 121a also stores one of the access request signals Port1_REQ1 and Port1_REQ2, for accessing the shared memory field 3200, into the second FIFO circuit 121c.

If the IP block 500 includes a plurality of IP blocks allocated to the first memory field 3100 and the second IP block 600 includes a plurality of IP blocks allocated to the shared memory field 3200, then the first and second FIFO circuits 121b and 121c can be structured as shown in FIG. 3.

Signals MEM1_1 through MEM1_3 stored in the first FIFO circuit 121b are the access request signals of the IP blocks for accessing the first memory field 3100. Signals SHR1_1 through SHR1_3 are the access request signals of the IP blocks for accessing the shared memory field 3200.

The access request signal MEM_1 is the signal having the highest priority from among the access request signals MEM1_1 through MEM1_3 and SHR1_1 through SHR1_3 and SHR1_3 is the signal having the lowest priority. Among the access request signal SHR1_1 through SHR1_3, SHR1_1 is the signal having the highest priority.

The priority of the access request signals MEM1_1 through MEM1_3 and SHR1_1 through SHR1_3 shown in FIG. 3 is arranged arbitrarily, but it may be arranged according to desired conditions.

The first arbiter logic circuit 121a generates first and second count signals, MEM1_count and SHR1_count, and the first selection signal Sel1 in response to the first and second port control signals Port1_busy and Port2_busy having high levels. During this, the second count signal SHR1_count does not conduct a counting operation but rather designates a point.

The first arbiter logic circuit 121a provides the first count signal MEM1_count to the first FIFO circuit 121b and the second count signal SHR1_count to the second FIFO circuit 121c. The first arbiter logic circuit 121a also provides the first selection signal Sel1 of a low level to the first multiplexer 123. The first FIFO circuit 121b outputs the access request signals, MEM1_1 through MEM1_3 and SHR1_1 through SHR1_3, through the first output terminal Arb1_1 of the first port arbiter 121c in response to the first count signal MEM1_count. The second FIFO circuit 121c designates a point to the access request signals SHR1_1 through SHR1_3, without a practical counting operation.

In detail, while the access request signal SHR1_1 of the first FIFO circuit is being counted, the access request signal SHR1_1 of the second FIFO circuit 121c is not counted but is rather designated as a point. The second FIFO circuit 121c does not output the access request signal SHR1_1. Even while the access request signals SHR1_2 and SHR1_3 of the first FIFO circuit 121b is being counted, the second FIFO circuit 121c operates in the same manner. Namely, the second FIFO circuit 121c withholds the access request signals SHR1_1 through SHR_3. Afterward, a procedure of outputting the access request signals MEM1_1 through MEM1_3 and SHR1_1 through SHR1_3 is as described above.

When the access request signals, MEM1_1 through MEM1_3 and SHR1_1 through SHR1_3, of the IP blocks are provided into the bus controller 110, the IP blocks 700 and 800 accessing the memory fields 3200 and 3300 through the second memory port 20 also apply the access request signals to the bus controller 110.When the access request signals MEM1_3 and SHR1_3 of the IP blocks are provided into the bus controller 110, the IP blocks 700 and 800 accessing the memory fields 3200 and 3300 through the second memory port 20 do not apply the access request signals to the bus controller 110. The operation of the first port arbiter 121 in such a case is described below with reference to FIGS. 3 and 5.

A procedure of outputting the access request signals MEM1_1, MEM1_2, SHR1_1, and SHR1_2 is similar to the manner described above. A procedure of storing the access request signals MEM1_3 and SHR1_3 into the first and second FIFO circuits 121b and 121c is similar to the manner described above.

The first arbiter logic circuit 121a generates the first and second count signals, MEM1_count and SHR1_count, and the first selection signal of low level in response to the first and second port control signals, Port1_busy and Port2_busy. The first and second control signals, Port1_busy and Port2_busy are of high levels and are provided from the first and second memory controllers 200 and 300.

The first arbiter logic circuit 121a provides the first count signal MEM1_count to the first FIFO circuit 121b, the second count signal SHR1_count to the second FIFO circuit 122b, and the first selection signal Sel1 of low a level to the first multiplexer 123.

The first FIFO circuit 121b outputs the access request signal MEM1_3 through the first output terminal Arb1_1 of the first port arbiter 121 in response to the first count signal MEM1_count. The first FIFO circuit 121b does not output the access request signal SHR1_3. Namely, the access request signal SHR1_3 is designated as a point, and is not counted in practice.

The second FIFO circuit 121c outputs the access request signal SHR1_3 by conducting a counting operation with the access request signal SHR1_3 in response to the count signal SHR1_count. The second FIFO circuit 121c conducts the counting operation with the access request signal SHR1_3 while designates a point to the access request signal SHR1_1. The access request signal SHR1_3 output from the second FIFO circuit 121c is provided to the first base address conversion circuit 121d. Accordingly, the first port arbiter 121 is able to inhibit a duplicate output of the access request signal SHR1_3.

Referring to FIG. 5, the shared memory field 3000 includes a region 3201 accessed through the first memory port 10, and a region 3202 accessed through the second memory port 20.

An address of the access request signal SHR1_3 output from the second FIFO circuit 121c includes a base address. As discussed above, the base address of the access request signal SHR1_3 output from the second FIFO circuit 121c is provided to the region 3202 of the shared memory field 3200. An address of the access request signal SHR1_3 originally output from the second FIFO circuit 121c is a base address Port1_base_addr for accessing the region 3201 of the shared memory field 3200 through the first memory port 10. Thus, the base address Port1_base_addr of the access request signal SHR1_3 output from the second FIFO circuit 121c corresponds with the region 3201 of the shared memory field 3200.

When the base address Port1_base_addr of the access request signal SHR1_3 output from the second FIFO circuit 121c is provided to the region 3202 of the shared memory field 3200 as described above, an abnormal designation of the base address Port1_base_addr is generated.

The first base address conversion circuit 121d converts the base address Port1_base_addr of the access request signal SGR1_3, which is output from the second FIFO circuit 121c, into a base address Port2_base_addr for accessing the region 3202 of the shared memory field 3200. The base address Port2_base_addr of the access request signal SHR1_3, is converted by the first base address conversion circuit 121d , and is then output through the second output terminal Arb1_1. The procedure for providing the access request signal SHR1_3 to the region 3201 of shared memory field 3200 through the second output terminal Arb1_1 is as described above.

The region 3202 of the shared memory field 3200 is accessed from the base address Port2_based_addr.

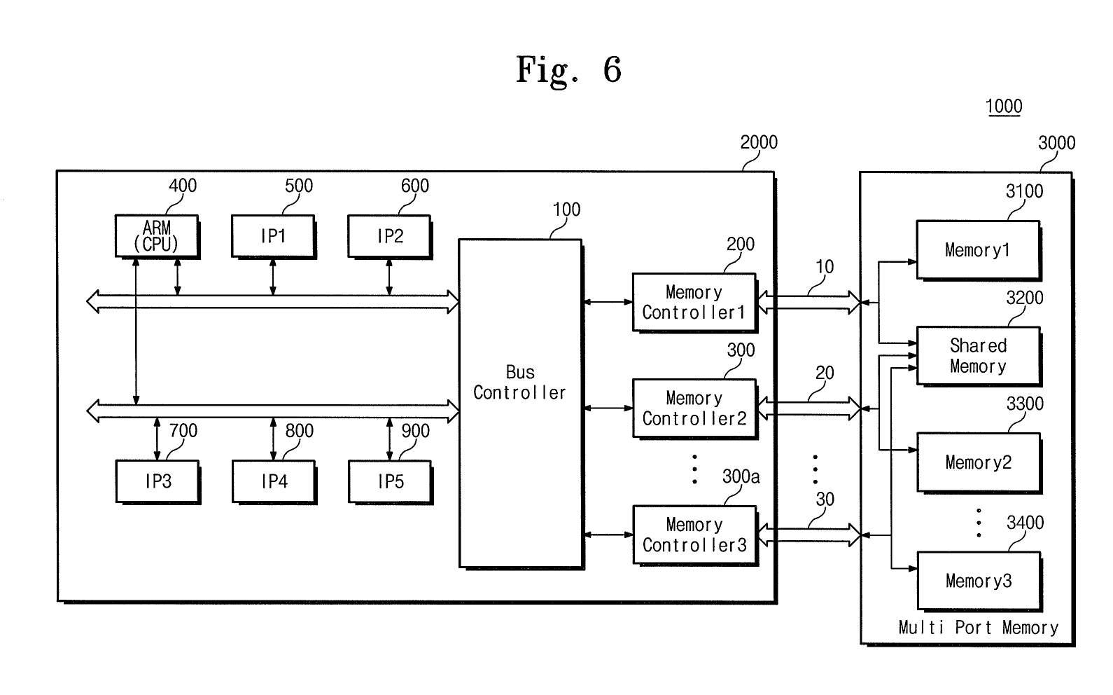

FIG. 6 is a block diagram of a microcomputer system according to an exemplary embodiment of the present invention.

Referring to FIG. 6, the microcomputer system 1000 according to an exemplary embodiment of the present invention is comprised of the CPU 400, a plurality of IP blocks 500 through 900, the bus controller 100, a plurality of memory controllers 200, 300, and 300a, a plurality of memory ports 10, 20, and 30, and the multi-port memory 3000. The microcomputer system 1000 shown in FIG. 6 is in some ways similar to that shown in FIG. 1 and the same reference numbers may indicate the same elements.

In the microcomputer system 1000 of FIG. 6, the memory fields are accessed through the memory ports 10, 20, and 30.

The microprocessor 2000 includes the IP blocks 500 through 900. The IP blocks 500 through 900 can output the access request signals REQ1 ˜through REQn.

If there is no output of the access request signals from the IP blocks accessing the memory field through the second and third memory ports 20 and 30, the first memory controller 200 is able to access the shared memory field 3200 through the second and memory ports 20 and 30.

If there is no output of the access request signals from the IP blocks accessing the memory field through the second memory port 20, the second and third memory controllers 200 and 300a are permitted to access the shared memory field 3200 through the second memory port 20 in accordance with their priority. Priority information is stored in the bus controller 100 as discussed above. The microcomputer system 1000 shown in FIG. 6 is configured to use the memory port that is arranged to be used by the IP blocks that withhold the access request signals, as discussed above with reference to the microcomputer system shown in FIG. 1.

An operation of the microcomputer system 1000 shown in FIG. 6 is substantially the same as for the microcomputer system shown in FIG. 1.

As described above, the microcomputer system according to an exemplary embodiment of the present invention has increased systemic performance and is able to access to the memory by efficiently using the memory ports.

The above-disclosed subject matter is to be considered illustrative, and not restrictive.

What is claimed is:

1. A microcomputer system comprising:
first and second IP blocks;
a multi-port memory including a first memory field, a shared memory field, and a second memory field;
a first memory controller configured to control access to the first and shared memory fields in response to a first access request signal;
a second memory controller configured to control access to the second and shared memory fields in response to a second access request signal; and
a bus controller operating in response to access requests of the first and second IP blocks,
wherein when the second memory controller is in a ready state and the first and second IP blocks request access to the first and shared memory fields, the bus controller provides the first memory controller with the first access request signal from the first IP block and provides the second memory controller with the second access request signal from the second IP block.

2. The microcomputer system as set forth in claim 1, wherein the first memory controller accesses the first memory field through a port in response to the first access request signal.

3. The microcomputer system as set forth in claim 1, wherein the second memory controller accesses the shared memory field through a port in response to the second access request signal.

4. The microcomputer system as set forth in claim 1, wherein the access requests of the first and second IP blocks occurs at the same time, at different times, or one after the other.

5. The microcomputer system as set forth in claim 1, wherein a region of the shared memory field accessed by the first memory controller is allocated differently than a region of the shared memory field accessed by the second memory controller.

6. The microcomputer system as set forth in claim 5, wherein the access request signal contains a base address.

7. The microcomputer system as set forth in claim 6, wherein the bus controller converts the base address of the access request signal of the second IP block into a base address of the shared memory field accessed by the second memory controller, and outputs the converted base address as the second access request signal.

8. The microcomputer system as set forth in claim 7 further including a third IP block and a fourth IP block, wherein when the third and fourth IP blocks request access to the second and shared memory fields, the bus controller provides the first memory controller with the first access request signal corresponding to the access request signals of the first and second IP blocks and provides the second memory controller with the second access request signal corresponding to the access request signals of the third and fourth IP blocks.

9. The microcomputer system as set forth in claim 8, wherein the first memory controller accesses the first and shared memory fields through a port in response to the first access request signal.

10. The microcomputer system as set forth in claim 8, wherein the second memory controller accesses the second and shared memory fields through a port in response to the second access request signal.

11. The microcomputer system as set forth in claim 1, further comprising:
a multi-port memory having a plurality of memory fields;
a plurality of memory controllers configured to access the memory fields and the shared memory field.

12. The microcomputer system as set forth in claim 1, wherein the bus controller comprises:
an address decoder receiving the access request signals from the first and second IP blocks;
a first port arbiter receiving the access request signals of the first and second IP blocks from the address decoder;
a second port arbiter; and
first and second multiplexers corresponding to the first and second port arbiters, respectively,
wherein the first port arbiter controls the first multiplexer with reference to status of the first and second memory controllers and provides the access request signal of the first IP block to the first memory controller as the first access request signal through the first multiplexer, and
wherein the second port arbiter controls the second multiplexer with reference to status of the first and second memory controllers and provides the access request signal of the second IP block to the second memory controller as the second access request signal through the second multiplexer.

13. The microcomputer system as set forth in claim 12, wherein the first port arbiter converts a base address of the access request signal of the second IP block into a base address of the shared memory field accessed by the second memory controller.

14. The microcomputer system as set forth in claim 12, wherein the address decoder further receives access request signals from third and fourth IP blocks and provides the access request signals of the third and fourth IP blocks to the second port arbiter.

15. The microcomputer system as set forth in claim 14, wherein the first port arbiter controls the first multiplexer by status signals of the first and second memory controllers and provides the access request signals of the first and second IP blocks to the first memory controller as the first access request signal through the first multiplexer.

16. The microcomputer system as set forth in claim 13, wherein the first port arbiter comprises:
a first FIFO circuit;
a second FIFO circuit;
a first arbiter logic circuit storing the access request signals in the first FIFO circuit and stores the access request signal in the second FIFO circuit; and
a base address conversion circuit converting a base address of the access request signal of the second IP block, which is output from the second FIFO circuit, into a base address of the shared memory field accessed by the second memory controller,
wherein the first arbiter logic circuit generates first and second count signals by the first and second memory controllers,
wherein the first FIFO circuit outputs the access request signal of the first IP block in response to the first count signal,
wherein the second FIFO circuit outputs the access request signal of the second IP block in response to the second count signal.

17. The microcomputer system as set forth in claim 16, wherein when the second port arbiter provides the access request signals of the third and fourth IP blocks to the second memory controller as the second access request signal through the second multiplexer, the first FIFO circuit outputs the access request signals of the first and second IP blocks in response to the first count signal.

18. A microcomputer system comprising:
first and second IP blocks;
a multi-port memory including a first memory field, a shared memory field, and a second memory field;
a first memory controller configured to control access to the first and shared memory fields;
a second memory controller configured to control access to the second and shared memory fields; and
a bus controller, wherein when the second memory controller is in a ready state and the first and second IP blocks request access to the first and shared memory fields, the bus controller provides the first memory controller with access to the first IP block and provides the second memory controller access to the second IP block.

19. The microcomputer system as set forth in claim 18, wherein the first memory controller accesses the first memory field through a port and the second memory controller accesses the shared memory field through the port.

20. A microcomputer system comprising:
first and second IP blocks;
a multi-port memory including a first memory field allocated to the first IP block, a shared memory field allocated to the second IP block, and a second memory field;
a first memory controller configured to control access to the first and shared memory fields in response to a first access request signal;
a second memory controller configured to control access to the second and shared memory fields in response to a second access request signal; and
a bus controller operating in response to access request signals provided from the first and second IP blocks by access requests of the first and second IP blocks,
wherein when the second memory controller is in a ready state and the first and second IP blocks request access to the first and shared memory fields, the bus controller provides the first memory controller with the first access request signal corresponding to the access request signal from the first IP block and provides the second memory controller with the second access request signal corresponding to the access request signal from the second IP block.
